(19) United States
(12) Patent Application Publication
(10) Pub. No.: US 2008/0197640 A1
(43) Pub. Date: Aug. 21, 2008

(54) METHOD AND APPARATUS FOR DRIVING A BOLT

(76) Inventor: Ronald C Clarke, Phoenix, AZ (US)

Correspondence Address: FISH & RICHARDSON P.C., P.O BOX 1022, Minneapolis, MN, 55440-1022, US

(21) Appl. No.: 11/676,428

(22) Filed: Feb. 19, 2007

(51) Int. Cl. E05C 19/04

(52) U.S. Cl. 292/73

(57) ABSTRACT

A method and apparatus for removing liner bolts over a range of impact angles is disclosed. Complimentary liner bolt and driving assembly features cooperate to control energy transfer during impact of the driving assembly upon the liner bolt. The liner bolt includes a convex annular portion on the end face of the bolt shank and a concave depression in the end face of the bolt shank. The driving assembly includes a concave driving face for impacting the convex annular portion of the bolt shank and a spring-loaded guide pin seated in the concave depression of the shank for guiding the concave driving face into contact with the bolt shank. A retraction collar may be associated with the guide pin through a slot in the driving member to retract the guide pin as the driving member chases the liner bolt from the surrounding structure. The respective profiles of the convex shank portion, concave depression, concave driving face, and guide pin accommodate impact angles of approximately between 0-15 degrees, providing increased versatility, efficiency, and safety in removing liner bolts.

### FIELD OF INVENTION

This invention generally relates to bolt removal methods and apparatuses. and more particularly, to the impact removal of liner bolts in mill applications.

### BACKGROUND OF THE INVENTION

Mills may be used in various mining operations and the mills typically include a segmented sacrificial liner bolted to the interior of a mill shell or casing. The sacrificial liner is routinely replaced as it becomes worn. The liner bolts typically extend from the mill interior to the exterior such that the head of the bolt is partially recessed or seated into holes or seats in the liner. Due to the harsh environment and forces present in Such mills, the heads and shanks of the liner bolts securing the liner to the mill interior often become corroded or tightly impacted in the liner seat by debris (e.g., ball charge and ore) and slurry, making removal difficult and time consuming, if not dangerous. For example, a typical removal method includes removal of any nuts and washers on the mill exterior and use of a sledge hammer to drive the bolt back into the mill interior. Removal of the last number of bolts is particularly difficult and dangerous as the liner may shift relative to the mill casing.

Various mechanical bolt removal means have been proposed, including the use of a jack hammer. Conventional use of a jack hammer, however, typically presents additional problems and dangers. For example, use of a jack hammer without a suitable positioning mechanism may result in equipment damage or operator injury due to misalignment and slippage. Similarly, misalignment results in poor energy transfer and the end of the bolt shank may become deformed beyond its cylindrical shape by misplaced jack hammer blows, making it even more difficult to remove a stubborn bolt. Additionally, due to the weight of the jack hammer and the impact forces to be applied to the shank of the bolt, the jack hammer may alternatively require time-consuming set-up of support structure to facilitate the necessary precision.

Another proposed method includes use of jack hammer ram having a blunt cylindrical alignment pin at the end of the ram for insertion into a deep cylindrical bore formed in the end of the shank of the bolt. Proper insertion of the cylindrical alignment pin into the bolt bore requires additional precision in the positioning of the jackhammer. More specifically, the bolt may only be driven with the jack hammer in precise longitudinal alignment, i.e., with the axis of the bolt shank aligned with the axis of the jack hammer ram. Misalignment of the ram and bolt shank can result in damage to the alignment pin, ram, jackhammer, or even to the operator. Proper alignment is not possible in some applications as their may not be sufficient space for a jack hammer directly in line with the bolt shank, for example, where the bolt is positioned near a floor, wall, or mill support structure or other hardware.

To keep the moil and alignment pin aligned with the bolt during repeated impacts, the bore in the shank of the bolt is typically formed to a depth proportionate to the bounce or recoil of the ram (e.g., several inches); otherwise, the alignment pin may leave the bore and impact the mill casing. Since the bore is formed in the bolt prior to installation, the bolt is typically lengthened by the respective depth of the cylindrical bore to prevent weakening and derating of the bolt strength. This additional length requires additional material, manufacturing expense, and a custom deepwell socket for tightening. Because the alignment pin is seated so deeply within the bolt, the pin may not separate cleanly from the bolt once loosened and may thus cause the bolt or pin to become caught by the shifting liner. Such pin problems result from the pin being separated from the bolt shank along a common longitudinal axis. For example, once the bolt is freed, the alignment pin or ram may chase the bolt becoming caught between the liner and mill casing if the liner shifts during the process. Alternatively, the bolt will remain on the end of the alignment pin when it would otherwise fall freely from the mill liner, increasing the frequency of liner bolts becoming caught by the liner as it falls from the mill casing. Removal of a bound bolt, alignment pin, or ram from between a shifted liner and the mill casing is an additional time-consuming step. It is desirable to prevent unnecessary delay given the expense of downtime on such costly and critical equipment.

Accordingly, there exists a need for a method and apparatus for facilitating more efficient liner bolt removal within a greater range of impact angles and with increased safety. Similarly, a need exists for a liner bolt removal method and apparatus using standard length liner bolts.

### SUMMARY OF THE INVENTION

While the way that the present invention addresses the disadvantages of the prior art will be discussed in greater detail below, in general, the present invention provides an efficient and versatile method and apparatus for removing bolts, wherein a shallow concave depression is formed in a convex end face of the liner bolt shank. The depression receives a guide pin for guiding a concave driving ram against the convex end face of the bolt shank within a range of impact angles or off-center ram positions. The guide pin may be spring-loaded to maintain close contact with the bolt between and during repeated impacts, for example, during recoil of the driving ram. A retraction collar adjacent the ram is configured to proportionately retract the spring-loaded guide pin as the ram chases the bolt from the mill casing, to prevent the pin from entering the liner and becoming damaged or bound by shifting of the liner within the mill casing.

In the exemplary context of mill liner bolts, a bolt includes any oval or other suitable head shape that tapers to a threaded shank and further includes a concave depression or pressure area formed into the end of the bolt shank. The concave depression receives a guide pin, ram, punch, and/or the like at various angles to the bolt shank to permit driving of the bolt within a range of impact angles. The concave depression facilitates ready separation of the bolt and guide pin or ram within a range of separation angles once the bolt is freed from its seat in the liner, to prevent binding of the bolt, guide pin, or ram upon shifting of the liner. In other words, the bolt shank and guide pin need not be aligned during separation, but may be cleanly separated within a range of angles roughly corresponding to a suitable range of impact angles.

In various embodiments, the ram itself may be shaped as a blunt, round-nosed punch and may be received directly in the depression in the bolt shank. In other embodiments, the ram may include a concave annular surface to impact the convex end face of the bolt shank adjacent the depression and may be guided by a guide pin extending from the driving ram and seated in the depression. The guide pin may be spring loaded to maintain contact with the depression during recoil of the ram. A moveable collar adjacent the ram and connected to the guide pin, for example, through a slot in the ram serves to retract the guide pin as the ram chases a bolt out of a hole in the liner casing.

According to an exemplary bolt removal method, a driving ram having a concave face is positioned adjacent a liner bolt having a concave depression formed in a convex end face of the bolt shank. The concave-faced driving ram carries a spring loaded guide pin that is seated in the concave depression. The concave-faced driving ram is then advanced to impact the convex portion of the bolt shank end. A collar attached to the guide pin retracts the guide pin so that it never extends beyond the inside surface of the mill shell as the driving ram chases the bolt from the hole.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates an exemplary prior art bolted mill liner assembly used in a conventional mining mill application;

FIG. 2 illustrates an exemplary liner bolt according to one embodiment;

FIG. 3 illustrates an exemplary driving assembly prior to contact with an exemplary liner bolt; and

FIG. 4 illustrates an exemplary driving ram and guide pin assembly in driving contact with an exemplary liner bolt, and wherein the driving ram is positioned at an angle to the liner bolt.

### DETAILED DESCRIPTION

The following description is of exemplary embodiments of the invention only, and is not intended to limit the scope, applicability or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, driving mechanisms and the like and still fall within the scope of the present invention. Thus, the detailed description herein is presented for purposes of illustration only and not of limitation.

In accordance with various embodiments of the present invention, a bolt is formed with a shank end face having a convex portion surrounding a concave depression. A driving ram is formed with a concave driving face for contacting the convex portion of the shank end and may include a guide pin for receipt in the concave depression to maintain positioning of the driving ram relative to the bolt shank during repeated impacts. The present invention may be used to facilitate removal of any elongated fastener such as a bolt, dowel or shaft that may become impacted, bound, or otherwise interferingly seated in a hole. That being said, the present invention is described herein in the exemplary context of a liner bolt used, for example, in mining mills. Accordingly, “bolt” or “liner bolt” as used herein, generally may be construed to mean any threaded, partially threaded, or unthreaded fastener and/or other hardware to be removed or dislodged from a surrounding structure using a driving ram.

The terms “driving member” or “driving ram” as used herein, include any ram, punch, chisel, or moil suitable to transfer an impact force to a bolt. Suitable driving members may be of any shape or size and in general, include a head configured to strike or otherwise contact a bolt or other driven member to impart an impact force, such as those forces generated by a hammer or by the repeated action of a jack hammer. In accordance with various embodiments, the driving member may be hand held for use with a sledge hammer. For heavier applications, the driving ram may be attached to a jack hammer or other suitable driving mechanism. It is understood that any process or material now known or later developed for forming a bolt or driving ram may be used in accordance with the present invention.

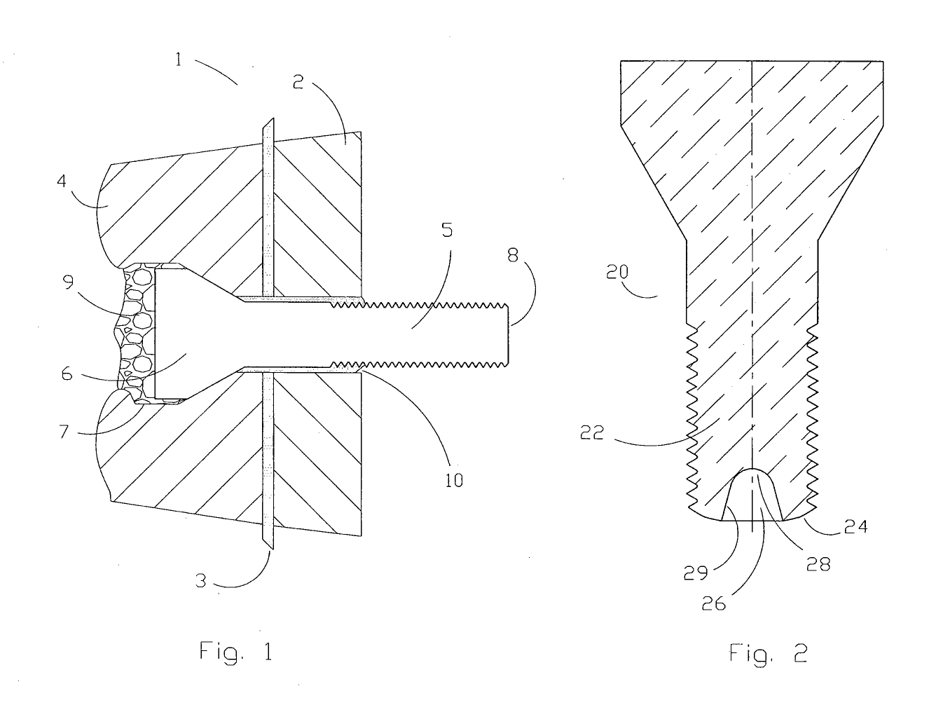

In the exemplary context of a mill liner application and with reference to FIG. 1, an exemplary prior art bolted mill liner assembly 1 includes a mill casing 2 carrying a rubber lining 3 and a sacrificial liner 4 secured to mill casing 2 by a liner bolt 5. Liner bolt 5 extends through lining 3, liner 4 and mill casing 2 with the liner bolt head 6 seated in a recess 7 in liner 4 and the liner bolt shank end 8 protruding from mill casing 2 for fastening using sealing washers and threaded nuts.

Space within recess 7 adjacent seated head 6 of liner bolt 5 often becomes tightly packed with debris 9 (e.g., ball chips and ore fragments) during operation of the mill. Similarly, space between any of liner 4, lining 3, mill casing 2 and liner bolt 5 may likewise become filled with corrosive slurry 10.

With reference now to FIG. 2, an exemplary liner bolt 20 according to one embodiment of the present invention includes a shank 22 having a convex end face portion 24 surrounding a concave depression 26 at the end of shank 22. However, the invention contemplates the convex portion 24 and/or concave depression 26 at any desired location on or around bolt 20. For example, the invention contemplates an adaptor or collar which may be fitted to any portion of bolt 20 or the ram device, wherein the adaptor may include convex portion 24 and/or concave depression 26.

Bolt 20, including convex portion 24 and concave depression 26, may be formed by forging or any other suitable forming process. Convex portion 24 and concave depression 26 may be formed simultaneous with shank 22, or subsequent thereto. For example, bolt 20 may be formed using hot or cold forming techniques and convex portion 24 and concave depression 26 may then be formed by upsetting, machining, or other suitable forming process or operation.

Convex portion 24 is configured to provide sufficient surface contact area to withstand full jack-hammer impact force, without causing upsetting. Convex portion 24 may range from a linearly tapered profile to a generally hemispherical profile. A hemispherically-profiled convex portion 24 provides optimized contact and versatility with a complementary hemispherically-profiled concave driver face for use in impacting bolt 20. In contrast to a conventional flat-ended bolt driven by a blunt driving ram where the surface area of the impact zone is highly dependent on the alignment of the axes of the bolt and ram, the complimentary hemispherical profiles of convex portion 24 and the concave driving ram face remain in substantial contact throughout a wide range of impact angles.

In this regard, experimentation with complimentary hemi-spherical profiles has demonstrated adequate energy transfer without upsetting of convex surface 24 up to at least 15 degrees off center. Stated otherwise, convex portion 24 may receive impacts from a driving ram angled 15 degrees or more in any direction from the longitudinal axis of shank 22. The profile of convex portion 24 may be selected to provide suitable contact area over any desired range of impact angles corresponding to the driving member alignment, for example, 0-5 degrees or 0-15 degrees. Accordingly, convex portion 24 may comprise any profile suitable to provide sufficient contact area with a specified driving member over a given range of driving member alignment angles.

The area of contact between bolt 20 and the driving member becomes a concern when repeated impacts are required to remove a stubborn bolt. In this case, the contact area increases as the repeated impacts of the driving member slightly reshapes the softer material of bolt 20. As the contact area increases, more energy from each impact of the driving member is transmitted into the bolt which is more effective in removing the bolt from the mill casing. The slight reshaping of the convex portion 24 tends to remain within the original cylindrical shape of the bolt shank so that the passage of the bolt through the hole in the mill casing is not hindered.

Concave depression 26 comprises a seat 28 and sidewall 29 configured to receive or guide any portion of a driving assembly. For example, seat 28 may be sized and profiled to receive the full impact force of a driving member and sidewall 29 may be profiled to accommodate a driving member in seat 28 up to a desired angle. In another embodiment, seat 28 may be configured to receive a guide pin configured to suitably direct a driving member to convex portion 24.

As similarly described with regard to convex portion 24, seat 28 may comprise a hemispherical profile to optimize versatility of positioning and angle of a driving member. Sidewall 29 extends from seat 28 to convex portion 24 and may be configured of any desired depth to accommodate a driving member or guide mechanism in a given application. For example, concave depression 26 may be formed with sufficient depth to retain a driving member or guide member partially seated during recoil of a driving member during repeated impacts. In another embodiment, as described below, depression 26 may be formed shallow while still of sufficient depth to retain a spring-loaded guide member therein. A shallow depression 26 provides various advantages over previous systems, for example, bolt 20 need not be lengthened or weakened to accommodate a shallow depression 26.

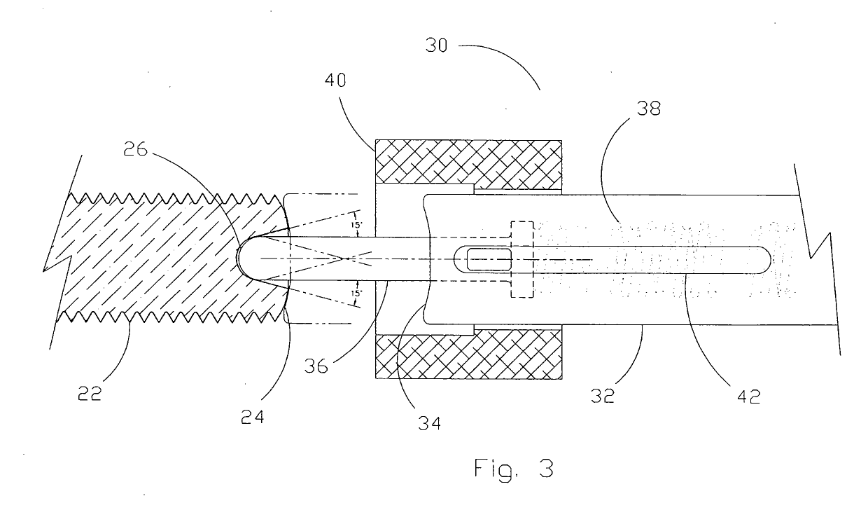

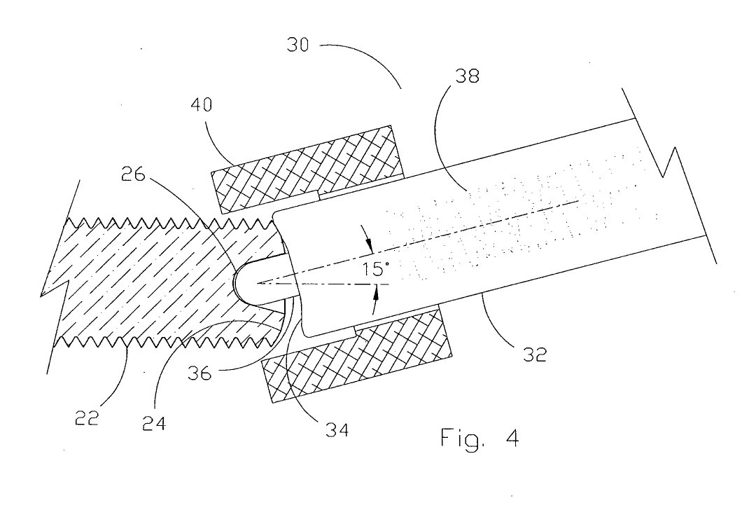

With reference now to FIG. 3, an exemplary driving assembly 30 is shown according to one embodiment of the present invention. Driving assembly 30 comprises an annular driving member 32 having a concave face 34 and a guide pin 36 extending beyond face 34 from within driving member 32. Guide pin 36 is biased in an extended position by a spring 38 received within driving member 32 behind guide pin 36.

Driving assembly 30 further comprises a retraction collar 40 disposed external to driving member 32 and connected to guide pin 36 through a slot 42 in driving member 32. Driving collar 40 is configured to contact the mill casing 2 (FIG. 1) as driving member 32 chases bolt 20 from a hole. Accordingly, advancement of driving member 32 into a hole previously occupied by bolt 20 causes collar 40 to proportionately retract guide pin 36. This configuration prevents guide pin 36 from extending beyond driving member 32 longer than necessary, for example, after bolt 20 has been sufficiently dislodged, preventing binding of or damage to guide pin 36.

Guide pin 36 may be configured as an elongated rod positioned within driving member 32. Experimentation has demonstrated increased versatility in the angle of incidence with an elongated guide pin 36 configured to be seated in concave depression 26. Guide pin 36 may be formed of any suitable length, size, cross-section or material for a given application.

Driving collar 40 may be configured as a sleeve around driving member 32 as illustrated. In this configuration, collar 40 provides an additional safety benefit of preventing injury due to the possibility of metal fragments flying off as a result of the repeated impacts. Alternatively, driving collar 40 may be configured as a singular projection from slot 42 or as any other feature suitable to urge guide pin 36 against spring 38 upon advancement of driving member 32 into an adjacent structure. In various alternative embodiments, spring 38 may be associated with collar 40 instead of guide pin 36 to provide suitable biasing forces to the combination thereof. Spring 38 may comprise a helical steel spring, a pneumatic cylinder or other suitable biasing mechanism.

With reference now to FIG. 4, driving assembly 30 is shown positioned at a 15 degree angle to bolt 20 with guide pin 36 partially retracted within driving member 32 during impact. Guide pin 36 lays against sidewall 28 and concave face 34 of driving member 32 contacts a section of convex portion 24 of shank 22.

An exemplary bolt removal method according to one embodiment comprises seating a spring-loaded guide pin extending from a concave-faced driving ram in a concave depression formed in a convex end face of a liner bolt shank. The method further comprises advancing the concave-faced driving ram, guided by the guide pin, to impact the convex portion of the bolt shank end. An optional collar attached to the guide pin retracts the guide pin as the driving ram chases the bolt from the hole.

An exemplary method of facilitating liner bolt removal with a driving member within a range of angles comprises providing a convex face portion at the end of the bolt shank configured to substantially complement a portion of a concave driving member face and providing a concave depression in the end of a bolt shank configured to receive a guide pin associated with the driving member such that the guide pin and driving member may be oriented at an angle to the bolt shank to transfer impact energy to the bolt. Depending on the angle, the convex end face portion and concave driving member may be complementary along any suitable contact arc length around the annular profile of the convex end face portion. In one embodiment, the contact surface area along the contact arc length is sufficient to prevent upsetting of the end face of the liner bolt shank under a predetermined load.

Another exemplary liner bolt removal method comprises providing a concave face on a driving member configured to contact a substantially complementary convex face portion of a bolt shank, providing a guide pin extending from the driving member and configured to engage a concave depression formed in the end of the bolt shank. The method further comprises providing a spring to bias the guide pin to remain at least partially within the concave depression in the bolt shank during recoil of the driving member, and advancing the driving member along the guide pin to impact the bolt shank.

An exemplary method of manufacturing a liner bolt comprises forming a liner bolt shank, forming a convex portion of the end face of the liner bolt shank and forming a concave depression in the end of the liner bolt shank. Forming the concave depression further includes forming a spherical seat and a concave or tapered sidewall intersecting the convex portion of the end face of the liner bolt. Any of the forming steps described herein may comprise forging, upsetting, grinding, drilling, or other suitable machining or forming operation.

An exemplary method of manufacturing a driving assembly for use in driving liner bolts within a range of impact angles includes forming a concave driving face on a driving member to cooperate with a convex portion of an end face of a bolt shank, and biasing a guide pin to extend from said driving member such that said guide pin seats within a concave depression in said bolt shank to guide said driving member into contact with said bolt shank.

Similarly, while the present invention has been described herein as a method and apparatus for removing liner bolts, the present invention may be readily used with any number of fasteners, pins, axles, shafts, rods, or other similar devices now known or hereafter developed which may benefit from controlled impact over a range of impact or separation angles.

Finally, while the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A liner bolt configured to facilitate removal, said liner bolt comprising:
a bolt shank having an end face;
a convex portion formed on said end face;
a concave depression formed at said end face, said concave depression comprising a seat and a sidewall.

2. The liner bolt of claim 1, wherein said convex portion is configured to provide a contact surface area with a concave face of a driving member over a range of impact angles.

3. The liner bolt of claim 2, wherein said seat of said concave depression is configured to receive a guide pin associated with said driving member and said sidewall of said concave depression is configured to accommodate said guide pin in said seat over a range of impact angles.

4. The liner bolt of claim 2, wherein said concave depression is configured to cooperate with said guide pin to guide said driving member into repeated sequential contact with said convex portion.

5. The liner bolt of claim 2, wherein said range of impact angles comprises approximately 0-15 degrees.

6. The liner bolt of claim 2, wherein said seat is substantially hemispherical and said sidewall is tapered between approximately 5 and 15 degrees.

7. A driving assembly for removal of liner bolts, said assembly comprising:
a driving member having a concave driving face configured to complement a convex face portion of a liner bolt shank;
a guide pin associated with said driving member and configured to cooperate with a concave depression in said liner bolt shank to guide said concave driving face of said driving member into contact with said convex face portion of said liner bolt shank.

8. The driving assembly of claim 7, wherein said guide pin is moveable against a spring biasing said guide pin in an extended position relative to said driving member.

9. The driving assembly of claim 8, further comprising a retraction collar connected to said guide pin and configured to retract said guide pin against said spring upon contact with an adjacent structure.

10. The driving assembly of claim 9, wherein said guide pin and said spring are disposed within said driving member and said retraction collar is disposed external to said driving member and is connected to said guide pin through a slot formed in said driving member.

11. The driving assembly of claim 7, wherein said guide pin is configured with a rounded tip for seating in said concave depression to accommodate impact angles of approximately between 0 and 15 degrees between said driving member and said bolt shank.

12. The driving assembly of claim 7, wherein said driving assembly is configured for at least one of hand use and use with a jack hammer.

13. The driving assembly of claim 7, wherein said concave depression and said guide pin are configured to cooperate together with sufficient tolerance to permit ready separation of said driving assembly from said bolt shank within a range of at least one of said impact angles and separation angles, wherein said at least one of said impact angles and separation angles is between approximately 0 and 15 degrees.

14. A method of removing a liner bolt with a driving member from within a range of impact angles, said method comprising:
providing a convex face portion at an end of a bolt shank, said convex face portion configured to substantially complement a portion of a concave driving face of a driving member; and
providing a concave depression in said end of said bolt shank, said concave depression configured to receive a guide pin associated with said driving member such that said guide pin and said driving member may be oriented at an angle to said bolt shank during impact.

15. The method of claim 14, wherein said convex end face portion and said concave driving member face are brought into complementary contact substantially to one side of said concave depression.

16. The method of claim 15, wherein said convex end face portion and said concave driving member face are configured to provide sufficient contact surface area during impact to substantially prevent upsetting of said end of said bolt shank under a predetermined load.

17. A liner bolt removal method comprising:
providing a concave face on a driving member configured to contact a substantially complementary convex face portion of a bolt shank;
providing a spring-loaded guide pin extending from within said driving member and configured to engage a concave depression formed in an end of said bolt shank; and
advancing said driving member along said guide pin to impact said bolt shank, wherein
said guide pin remains at least partially within said concave depression in said bolt shank during recoil of said driving member.

18. A method of manufacturing a liner bolt comprising:
forming a liner bolt shank;
forming a convex portion on an end face of said liner bolt shank; and
forming a concave depression in said end face of said liner bolt shank.

19. The method of claim 18, wherein said step of forming said concave depression further comprises forming a hemispherical seat and a tapered sidewall intersecting said convex portion of said end face of said liner bolt shank.

20. A method of manufacturing a driving assembly for use in driving liner bolts within a range of impact angle, said method comprising:
forming a concave driving face on a driving member configured to cooperate with a convex portion of an end face of a liner bolt shank, and
disposing and biasing a guide pin to extend from within said driving member such that said guide pin seats within a concave depression in said bolt shank to guide said driving member into contact with said liner bolt shank.
